(19) United States
(12) Patent Application Publication
(10) Pub. No.: US 2026/0287709 A1
(43) Pub. Date: Sep. 24, 2026

(54) APPARATUS AND METHOD FOR DETECTING RADAR INTERFERENCE IN A RADAR SYSTEM

(71) Applicant: Infineon Technologies AG, Neubiberg (DE)

(72) Inventors: Abdülkadir Eryildirim, Linz (AT); Dian Tresna Nugraha, Bandung (ID)

(21) Appl. No.: 19/569,135

(22) Filed: Mar. 17, 2026

(30) Foreign Application Priority Data
Mar. 20, 2025 (DE) 10 2025 110 931.1

(51) Int. Cl. G01S 7/02; G01S 7/35

(52) U.S. Cl. CPC G01S 7/023; G01S 7/356

(57) ABSTRACT

Provided is a method for detecting radar interference in a radar system. The method includes receiving a time-domain radar signal, performing a short-time Fourier transform (STFT) on the time-domain radar signal to generate a time-frequency representation of the radar signal, determining differences between consecutive segments of the time-frequency representation to identify frequency variations indicative of interference, and detecting radar interference based on the identified frequency variations

### REFERENCE TO RELATED APPLICATION

This Application claims the benefit of German Application number 102025110 931.1, filed on March 20, 2025, the contents of which are hereby incorporated by reference in their entirety.

### FIELD

The present disclosure generally relates to radar signal processing, and more particularly to methods and apparatuses for detecting and addressing weak radar interference in radar systems.

### BACKGROUND

Radar systems, in particular Frequency-Modulated Continuous-Wave (FMCW) radar systems, are widely employed in applications such as automotive sensing, where they may enable precise detection and tracking of objects by transmitting frequency-modulated chirps and analyzing reflected signals. As deployment of radar-equipped devices increases, particularly in the automotive industry, interference between radar systems operating in overlapping frequency bands has become a significant technical challenge. This interference, which can manifest as wide-band or crossing signals, can corrupt radar measurements, degrade system performance, and ultimately lead to missed detections or false alarms.

Interference detection techniques have primarily focused on time-domain processing, employing methods such as high-pass filtering, derivative-based thresholding, or energy detection to identify impulse-like interference patterns in radar signals. While these approaches can effectively detect strong interference, they may fail to reliably detect weak interference, particularly in scenarios where the interference power is comparable to or weaker than the target signal. Weak interference can distort the radar signal, increasing the noise floor and obscuring low-power targets, which may be critical for applications like collision avoidance and advanced driver assistance systems (ADAS). Moreover, the reliance on time-domain methods may limit the ability to fully exploit the spectral characteristics of interference, resulting in suboptimal detection accuracy.

The drawbacks of the prior art highlight a need for an improved approach to radar interference detection, particularly one that can reliably identify weak interference and better leverage spectral characteristics to enhance detection robustness. Accordingly, it may be desired to provide methods and apparatuses for radar interference detection that may overcome the limitations of time-domain processing and enable a reliable detection of interference, including weak interference, while maintaining computational efficiency.

### SUMMARY

This need is addressed by methods and apparatuses in accordance with the independent claims. Possibly advantageous embodiments are addressed by the dependent claims.

According to a first aspect of the present disclosure, it is proposed a method for detecting radar interference in a radar system. The method includes receiving a time-domain radar signal. The method further includes performing a short-time Fourier transform (STFT) on the time-domain radar signal to generate a time-frequency representation of the radar signal. The method further includes determining differences between consecutive segments of the time-frequency representation to identify frequency variations indicative of interference. The method further includes detecting radar interference based on the identified frequency variations.

Thus, it is proposed a method for identifying interference in a radar system. The method starts by processing the radar signal as it is received in its original form, which is represented as a signal varying over time. The signal may be captured in digital form, comprising discrete samples that represent the radar signal's amplitude at specific points in time. To analyze the signal more effectively, a mathematical operation called STFT is applied. This operation converts the time-domain signal into a time-frequency representation, essentially breaking the signal into smaller segments and analyzing how its frequency content changes over time. After creating this time-frequency representation, the method looks at consecutive segments of the data to identify any differences in the frequency patterns. These differences are examined because they can indicate interference, such as unexpected frequency variations (in fast time) caused by interfering signals from other radar systems. Based on the identified variations, the system can then determine whether interference is present in the radar signal. In simpler terms, this method allows the radar system to detect when unwanted signals are disrupting its operation by analyzing changes in frequency over time.

In radar systems, reliable interference detection may be needed for maintaining accurate target tracking and signal processing performance. Traditional time-domain (and) threshold-based detection algorithms, such as the Constant False Alarm Rate (CFAR) algorithm, are widely used to identify interference by dynamically adjusting detection thresholds based on the noise floor of the radar signal. However, the presence of strong target reflections in the radar signal can significantly impact the effectiveness of such detectors. Target reflections may dominate the signal, introducing a bias in the threshold calculation and masking the presence of weaker interference signals. This presents a challenge for detecting subtle or weak interference patterns, especially in dense or cluttered radar environments.

To address this issue, preprocessing techniques may be used for reducing or removing the influence of target reflections in the STFT output, which forms the basis for interference detection. One approach may involve dampening the contribution of target signals within the STFT representation. By reducing the amplitude of target-related components, the interference becomes more prominent in the data, enabling CFAR and similar detectors to operate with greater accuracy. This approach may ensure that the detection thresholds are less affected by strong, predictable target signals.

An alternative approach may involve completely removing the target-only signals from the STFT output, leaving behind the residual components, including potential interference. This method may isolate interference signals, which are often non-stationary or wide-band, and eliminate the predictable, stationary characteristics of target reflections. By doing so, the system may provide a cleaner input for traditional detectors, such as CFAR, allowing them to more effectively identify interference.

Both approaches may enhance the ability of radar systems to detect interference, particularly weak interference that may otherwise be overshadowed by strong target reflections. These techniques may be particularly relevant for automotive radar systems, where multiple radars operating in close proximity often result in complex interference scenarios. By preprocessing the radar signal in the frequency domain and minimizing the impact of target reflections, the proposed methods may enable more robust and reliable interference detection, even in challenging environments.

In some embodiments, performing the STFT on the time-domain radar signal comprises dividing the time-domain radar signal into a plurality of segments in accordance with a defined windowing parameter, applying a windowing function to each segment, performing a discrete Fourier transform (DFT) on each windowed segment to obtain a frequency-domain representation of that segment, and combining the frequency-domain representations of the segments to form the time-frequency representation including magnitude and phase information across time and frequency. This describes how the radar signal may be processed to transform it into a format that reveals how its frequency content changes over time. The process may begin by taking the radar signal, which exists as a continuous stream of data over time, and breaking it into smaller, manageable pieces or segments. This segmentation may be guided by a specific parameter, which defines how large each segment should be and whether these segments overlap with one another. Once the signal is divided into segments, a mathematical function, known as a windowing function, may be applied to each segment. This function may smooth edges of each segment to minimize abrupt transitions that could distort the analysis. After applying the windowing function, a mathematical operation called the DFT may be performed on each segment. This operation converts the signal in that segment from the time domain into the frequency domain, essentially revealing the different frequency components present in that specific segment. Finally, the frequency-domain data from all the segments may be combined to form a complete representation of how the signal's frequency content varies over time. This is known as the time-frequency representation, and it includes both the magnitude (strength) and phase (timing) information of the signal across different frequencies and time intervals.

In some embodiments, the windowing function applied to the segments is selected from a group comprising a Hamming window, a Hanning window, a Blackman window, a Chebyshev window, a Kaiser window, and a rectangular window. The purpose of the windowing function is to shape the data within each segment to reduce any abrupt changes at the segment boundaries, which could otherwise create distortions or artifacts during the frequency analysis. Different types of windowing functions can be used, each with its own unique properties and advantages depending on the application. These functions, such as the Hamming, Hanning, Blackman, Chebyshev, Kaiser, or rectangular windows, define how the edges of each segment are tapered or smoothed. Some windows are designed to minimize certain types of errors or improve resolution in the frequency domain, while others are simpler but may allow for more distortion. The selection of a specific windowing function depends on the desired balance between accuracy, noise suppression, and computational efficiency in the radar signal processing.

In some embodiments, a window length is configured to be equal to or shorter than a chirp length of the radar signal, and a step size between consecutive windows is defined as a fixed fraction of the window length. This described how the radar signal may be divided into smaller segments for analysis. The length of each segment, called the window length, may be set to be either equal to or shorter than the duration of a single radar chirp, which is the basic unit of a radar signal. By matching or shortening the window length to the chirp length, the analysis focuses on portions of the signal that correspond to individual chirps or smaller parts of them. The step size refers to how far the analysis moves forward in time to create the next segment. Instead of completely starting a new segment without overlap, the step size is defined as a fixed fraction of the window length. This means there may be partial overlap between consecutive segments, allowing smoother transitions and better continuity in the analysis. This overlap may improve the accuracy of detecting changes in the signal, such as interference or other anomalies, by ensuring that no important details are missed between segments.

In some embodiments, detecting radar interference comprises applying at least one threshold-based detection criterion to the determined differences, and identifying time segments of the radar signal as containing radar interference based on differences that exceed the at least one threshold-based detection criterion. This describes how the system may identify radar interference by using a threshold-based method. After analyzing the radar signal and calculating the differences between segments in the time-frequency representation, the system may evaluate these differences against a predefined threshold. This threshold may act as a benchmark to determine whether the differences are significant enough to indicate interference. If the differences exceed the threshold, it suggests that interference is present. The system may then identify the specific time segments of the radar signal where these large differences occur, marking them as areas affected by interference. In simpler terms, the system may use a set limit to decide whether a detected change in the signal is normal or caused by interference, and it pinpoints the exact parts of the signal where the interference is detected.

In some embodiments, detecting radar interference comprises a two-stage thresholding process. A first threshold may be applied to detect a presence of interference. A second threshold may be applied to identify specific (STFT) frequency bins or time segments of the time-frequency representation affected by interference. This describes a method of detecting radar interference using a two-step process involving thresholds. In the first step, a threshold may be applied to determine whether interference is present in the radar signal. This step may provide a general indication that interference has occurred without specifying exactly where it is located. In the second step, a more refined threshold may be used to pinpoint the specific parts of the signal that are affected by the interference. This may involve identifying exact frequency ranges (frequency bins) or time intervals (time segments) within the time-frequency representation where the interference is present. This two-stage approach may allow the system to first confirm the presence of interference and then locate its precise impact on the radar signal.

In some embodiments, determining differences between consecutive segments of the time-frequency representation comprises, for each STFT frequency bin, computing an absolute difference between corresponding elements in the consecutive segments. This describes how differences between consecutive parts of the radar signal may be analyzed to detect interference. Specifically, the process may focus on individual STFT frequency bins, which represent specific frequency ranges within the signal. For each STFT frequency bin, the system may compare the corresponding values in two consecutive segments of the time-frequency representation. It may calculate the absolute difference between these values, meaning it may measure the size of the change without considering whether it increased or decreased. By examining these absolute differences across all frequency bins, the system may identify unusual changes in the signal that may indicate the presence of interference. Thus, even subtle variations in specific frequency ranges may be detected and analyzed.

In some embodiments, detecting radar interference comprises comparing the determined differences to a predefined threshold to identify segments with frequency variations indicative of interference, and classifying the segments with differences exceeding the threshold as indicative of radar interference. This describes how the system may detect radar interference by evaluating changes in the radar signal. First, the system may look at the differences it has calculated between consecutive parts of the signal's time-frequency representation. These differences may then be compared to a predefined threshold, which may act as a benchmark to determine whether the variations in the signal are significant enough to suggest interference. If the differences exceed the threshold, the system may identify those specific parts of the signal, or segments, as being affected by interference. Essentially, the system may use the threshold to distinguish normal variations in the radar signal from abnormal changes caused by interference and marks the affected segments accordingly.

In some embodiments, the method further comprises dynamically adjusting the predefined threshold based on a noise floor level of the radar signal. The noise floor may be determined by analyzing magnitude values of the time-frequency representation over a predefined time and frequency range. This describes a process where the system may adjust the threshold used for detecting interference based on the noise level present in the radar signal. The noise floor represents the baseline level of background noise in the radar signal, which can vary depending on the environment or operating conditions. To determine this noise floor, the system may analyze the magnitude values of the radar signal's time-frequency representation over a specific range of time and frequencies. By understanding the noise floor, the system can dynamically adjust the threshold to account for varying noise levels. This may ensure that the detection process is more accurate, avoiding false detections caused by noise while still being sensitive enough to identify interference. In simpler terms, the threshold may be adapted in real time to match the current noise environment of the radar signal.

In some embodiments, the method further comprises applying non-coherent integration (NCI) across frequency bins in the time-frequency representation. Frequency bins represent specific frequency ranges within the signal. NCI involves combining the magnitude values of the signal across these frequency bins without considering the phase information. This process may enhance the overall detection of interference by smoothing out variations and amplifying consistent patterns across the frequency spectrum. By applying NCI, it may be easier to identify interference signals that might otherwise be obscured by noise or subtle fluctuations in individual frequency bins. This approach may increase the reliability and robustness of the interference detection process.

In some embodiments, detecting radar interference comprises employing a constant false alarm rate (CFAR) algorithm to dynamically adjust detection thresholds based on the noise floor across frequency bins. The CFAR algorithm may dynamically adjust the thresholds used to detect interference by analyzing the noise floor across the frequency bins in the radar signal. The noise floor represents the baseline level of background noise in the signal and can vary depending on the environment or operating conditions. By dynamically adjusting the detection thresholds to match the current noise floor, the CFAR algorithm may ensure that the system can reliably identify interference without being overly sensitive to noise or missing subtle interference signals. This may maintain a consistent balance between detecting true interference and minimizing false alarms, even in changing noise environments.

In some embodiments, the method further comprises applying a high-pass filtering operation to each frequency bin in the time-frequency representation (spectrogram). A high-pass filter is a technique which may be used to remove or suppress low-frequency components of the signal while allowing higher-frequency components to remain. By applying this filtering operation to each frequency bin, the method may focus on the parts of the signal that are more likely to contain interference or other relevant information, while reducing the impact of low-frequency noise or unwanted signal components. This may improve the accuracy and reliability of the interference detection process by enhancing the clarity of the signal in the frequency ranges of interest.

In some embodiments, the method further comprises, prior to performing the STFT, applying a high-pass filter to the time-domain radar signal. This means that, in some cases, the method may include applying a high-pass filter to the radar signal while it is still in its original time-domain form, before performing STFT. A high-pass filter is a process that removes or reduces low-frequency components from the signal, allowing higher-frequency components to pass through unaffected. By applying this filter before transforming the signal into its time-frequency representation, the method may eliminate unwanted low-frequency noise or interference early in the process. This may ensure that the subsequent STFT analysis focuses on the more relevant high-frequency components, improving the accuracy and efficiency of the interference detection process.

In some embodiments, the STFT is performed using a hardware-accelerated fast Fourier transform (FFT) processor. The FFT is a mathematical operation that converts a signal from the time domain to the frequency domain, and it can be computationally intensive when processing large amounts of data. By using a hardware-accelerated FFT processor, the system can perform these calculations much faster and more efficiently compared to relying on general-purpose processors. This hardware acceleration may be especially important in radar systems, where real-time processing is critical for detecting interference and ensuring accurate performance. It may allow the system to handle complex signal analysis with minimal delay and reduced computational load.

In some embodiments, the method further comprises dynamically adjusting a chirp length of the radar signal during operation based on the detected interference. This means that the method may include the ability to dynamically change the duration of the radar signal's chirp during operation, depending on the presence of interference. A chirp is a type of radar signal that sweeps through a range of frequencies over a specific period of time. The chirp length refers to the time duration of this frequency sweep. When interference is detected, the system may adjust the chirp length in real time to minimize the impact of the interference or to avoid overlapping with interfering signals. By adapting the chirp length dynamically, the radar system may maintain its performance and accuracy, even in challenging environments where interference is present. This approach may ensure reliable operation by optimizing the radar signal to reduce interference effects.

In some embodiments, the method further comprises reconstructing the radar signal by mitigating interference based on the identified frequency variations. This means that the method may include the ability to reconstruct the radar signal after interference has been detected. Once the system identifies the specific frequency variations caused by interference, it may apply techniques to mitigate, or reduce, the impact of that interference on the radar signal. By doing this, the system may restore the signal to a cleaner state, making it more accurate and reliable for further processing, such as detecting and tracking targets. This reconstruction process may ensure that the interference does not degrade the radar's performance, allowing it to function effectively even in environments with significant interference.

In some embodiments, the method further comprises analyzing the time-frequency representation using a machine learning algorithm trained to distinguish between clean signals and signals affected by interference. The algorithm may be trained to recognize patterns that distinguish clean, interference-free signals from those that have been affected by interference. By leveraging machine learning, the system may automatically and reliably identify interference in the signal, even when the interference is subtle or complex. This approach may enhance the system's ability to detect and classify interference more accurately than traditional methods, making it particularly useful in challenging or dynamic environments where interference patterns may vary.

In some embodiments, the radar system is a FMCW radar system. FMCW radar works by continuously transmitting a frequency-modulated signal, known as a chirp, and simultaneously receiving reflected signals from objects in the environment. By analyzing the frequency difference between the transmitted and received signals, the radar system can determine the distance and relative speed of objects. The method may be particularly applicable to FMCW radar systems, which are commonly used in applications such as automotive radar, where detecting interference is critical for accurate object detection and tracking.

In some embodiments, the method further comprises altering transmission parameters of the radar system upon detecting interference. Transmission parameters, such as frequency range, chirp duration, or timing of the radar signal, can be modified in response to the interference. By altering these parameters, the radar system may avoid overlapping with the interfering signals or reduce their impact, allowing it to continue operating effectively. This dynamic adjustment may maintain the radar system's performance and reliability in environments where interference from other radar systems or external sources is present.

The described method may be implemented as a computer-implemented method, wherein the steps of the method are executed by a computing system or processor integrated into the radar system. The processor may be configured to perform operations such as receiving and processing the time-domain radar signal, applying a STFT, determining frequency variations, detecting interference, and dynamically adjusting radar parameters. These operations may be executed as software instructions stored on a non-transitory computer-readable medium or as firmware running on specialized hardware components. By utilizing a computer-implemented approach, the method can achieve high-speed processing, precision, and adaptability, enabling real-time interference detection and mitigation in radar systems.

According to a further aspect of the present disclosure, it is proposed an apparatus for detecting radar interference in a radar system. The apparatus comprises processing circuitry configured to receive a time-domain radar signal, perform a STFT on the time-domain radar signal to generate a time-frequency representation of the radar signal, determine differences between consecutive segments of the time-frequency representation to identify frequency variations indicative of interference, and detect radar interference based on the identified frequency variations.

### BRIEF DESCRIPTION OF THE FIGURES

Some examples of apparatuses and/or methods will be described in the following by way of example only, and with reference to the accompanying figures, in which

FIG. 1A illustrates a simulated time-domain radar signal with a single target and a strong interferer;

FIG. 1B illustrates a simulated time-domain radar signal with a single target and a weak interferer;

FIG. 2A illustrates a STFT analysis of clean signal with a single target;

FIG. 2B illustrates a STFT analysis of signal with a weak interferer;

FIG. 3 shows a flowchart of a method for detecting radar interference in a radar system, according to an embodiment;

FIG. 4A is a block diagram of an example interference detection method, according to an embodiment;

FIG. 4B is the block diagram of FIG. 4A with example outputs of the individual blocks, according to an embodiment;

FIG. 5A illustrates difference and thresholding for each frequency bin, according to an embodiment;

FIG. 5B illustrates integration over frequency bins, continued with difference and thresholding, according to an embodiment;

FIG. 5C illustrates employing a high-pass filter per frequency point, according to an embodiment;

FIG. 6 illustrates interference detection in case of weak interferer (value of 1 shows the detection while value of zero means that there is no interference), according to an embodiment; and

FIGS. 7A, 7B illustrate a simulation of weak interferer 4 targets with RX noise and other impairments.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, "at least one of A and B" or "A and/or B" may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms "include", "including", "comprise" and/or "comprising", when used, describe the presence of the specified features, integers, steps, operations, processes, elements, components and/or a group thereof, but do not exclude the presence or addition of one or more other features, integers, steps, operations, processes, elements, components and/or a group thereof.

FMCW radar with chirps, which is also referred to as chirp sequence FMCW, is commonly used by automotive industry. One of the most significant challenges that the industry must resolve is the radar-to-radar (e.g., FMCW vs FMCW) interference. Since the number of cars being equipped with at least one radar sensor is increasing rapidly, the radar systems must be capable of operating in the presence of other interfering radar systems.

To deal with interference, interference detection, mitigation (signal reconstruction etc.) and avoidance may be applied. Interference detection may be used as an indispensable and first step since almost all interference mitigation and avoidance methods rely on reliable detection of occurrence of interference. Reliable interference detection may enable improved mitigation and avoidance, which is becoming a requirement for current and next generation automotive radar systems.

The most probable interference in automotive radar is called as crossing or wide-band interference where the interferer FMCW signal with different waveform configuration, e.g., different ramp slope, crosses the victim FMCW signal. This results in a linear chirp signal after RX mixing in the victim radar. Going through RX bandpass filters in the victim radar, the interference signal at the RX output becomes like an impulse-like signal in the time domain, thus corrupting whole IF band. In fact, duration of the interferer impulse depends on waveform configuration of victim and interferer. The power of the interferer depends on the scenario and radar configuration.

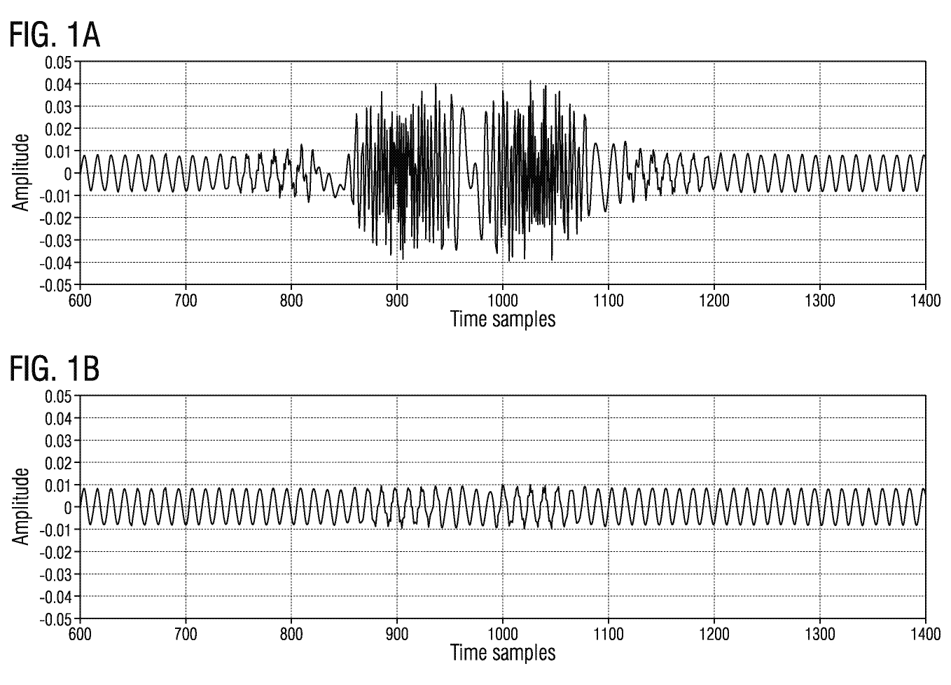

FIG. 1A shows the effect of a strong interferer on a radar signal in the time domain. The horizontal axis represents time samples, while the vertical axis represents the amplitude of the signal.

On both sides of the plot, the signal appears relatively clean and periodic, resembling a sinusoidal waveform. This corresponds to the radar's original chirp signal that is uncorrupted by interference. In the central portion of the figure, however, the signal becomes highly distorted. This distortion is characterized by large, irregular fluctuations in amplitude, which disrupt the original periodic structure of the waveform. The central distorted region is caused by the presence of a strong interferer. The interferer introduces an impulse-like effect, where the interference dominates the signal, resulting in a chaotic and noisy appearance. This disturbance spans multiple time samples, obscuring the original radar signal during this period. Once the interference subsides, the radar signal returns to its normal sinusoidal pattern, as seen towards the right side of the plot. This figure demonstrates how strong interference can overwhelm a radar signal, significantly altering its amplitude and structure in the affected time segment. Such interference can lead to a loss of critical radar information, impacting the system's ability to detect and track objects.

FIG. 1B illustrates the effect of a weak interferer on a radar signal in the time domain. The horizontal axis represents time samples, and the vertical axis represents the amplitude of the signal.

In contrast to FIG. 1A showing strong interference, the waveform here appears clean and periodic throughout the entire time range, resembling a near-perfect sinusoidal signal. The signal has consistent amplitude and frequency, with no obvious visual indications of distortion or disruption. This suggests that the power of the interference is much lower than or comparable to the power of the original radar signal. The weak interference does not significantly alter the time-domain appearance of the radar signal. As a result, any potential disruption caused by the interferer is not immediately noticeable in this representation. This figure demonstrates that when the Signal-to-Interference Ratio (SIR) is high—meaning the target signal is stronger than the interfering signal—the interference may blend into the radar signal and become challenging to detect visually in the time domain. This illustrates the difficulty in detecting weak interference using traditional time-domain analysis methods, as the impact is subtle and not easily distinguishable from the original radar signal.

While the interferer is weak, the impact on noise floor is still significant, yielding significant noise level increase. Therefore, it is important that weak interferer is detected. Here, the proposed detection method tackles this problem of weak interferer and leads to an improved performance of the subsequent radar signal processing steps.

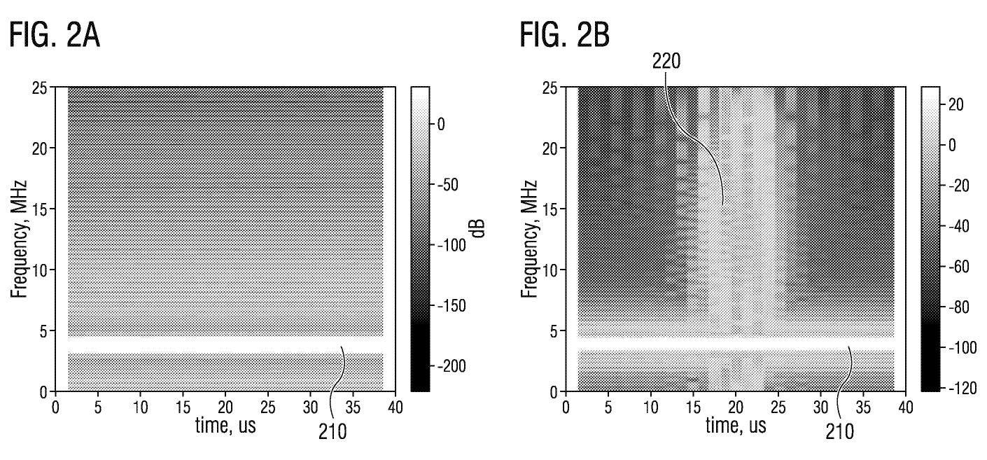

FIG. 2A illustrates a Short-Time Fourier Transform (STFT) spectrogram that represents the frequency content of an FMCW radar signal over time. The horizontal axis represents time in microseconds (μs), the vertical axis represents frequency in megahertz (MHz), and the scale indicates the signal power in decibels (dB).

The spectrogram of FIG. 2A shows a prominent horizontal line 210 at a specific frequency, slightly below 5 MHz, which remains consistent over the entire time range of 0 to 40 microseconds. This horizontal line 210 corresponds to the Intermediate Frequency (IF) or beat frequency of the radar signal, which remains constant because the signal is generated by a single point target at a fixed range. The constant frequency indicates that the target's range does not change during the observation period, as the frequency of the IF signal is directly proportional to the distance between the radar and the target. The scale of the horizontal line 210 represents a high power of the radar signal at the corresponding frequency. The surrounding area in the spectrogram indicates regions of lower power or noise, with values lower in decibels. The overall stability of the horizontal line 210 demonstrates that the radar signal contains no significant frequency variation over time. This is consistent with an ideal behavior of an FMCW radar observing a stationary target, where the frequency content is dominated by the single IF signal. The spectrogram of FIG. 2A effectively illustrates a clean and stable frequency content of the radar signal in this ideal scenario.

FIG. 2B is an STFT spectrogram illustrating an effect of interference on an FMCW radar signal. The horizontal axis represents time in microseconds (μs), the vertical axis represents frequency in megahertz (MHz), and the scale represents the power of the signal in decibels (dB).

The spectrogram of FIG. 2B also shows the dominant horizontal line 210 slightly below 5 MHz, which corresponds to the IF frequency of the radar signal generated by a target at a fixed range. This line 210 remains visible throughout the time range, indicating that the target signal's energy is still present despite the interference. However, unlike the clean spectrogram (FIG. 2A), this plot exhibits noticeable distortions 220 caused by interference. In particular, around the middle of the time range (approximately 15 to 25 microseconds), the interference causes additional energy to spread across multiple frequencies. This appears as vertical streaks or bands of higher power, extending from 0 MHz to higher frequencies (up to 25 MHz).These vertical bands appear irregular, with varying intensity levels in the affected time segments. This indicates that the interference introduces significant variations in the frequency content, disrupting the clean and stable horizontal line 210 observed in the interference-free spectrogram. Outside the affected time segments, the surrounding frequency bins indicate low power or noise levels similar to the clean signal.

The plot of FIG. 2B visually demonstrates how (weak) interference may alter the frequency content of the radar signal, introducing patterns that are distinct from those of a clean signal. While the overall energy in the time-domain signal may remain unchanged, the interference may create clearly identifiable distortions in the frequency domain. These distortions may spread over a wide range of frequencies, significantly affecting the time-frequency representation. This spectrogram underscores the advantage of using frequency-domain analysis, as the interference becomes more discernable through the patterns it creates in the time-frequency representation.

The proposed concept exploits these differences between clean and interfered signals to reliably detect interference.

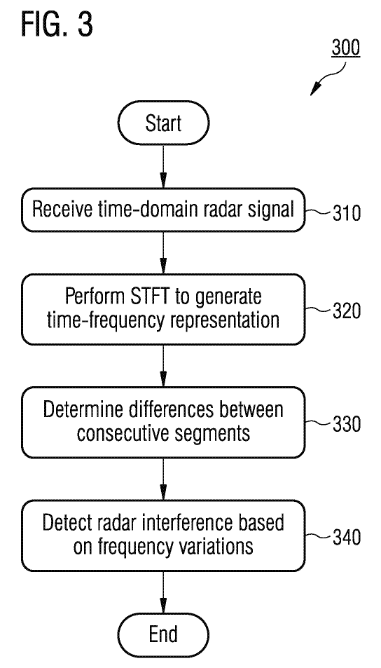

FIG. 3 illustrates a schematic flowchart of a proposed method 300 for detecting radar interference in a radar system.

Method 300 includes receiving 310 a time-domain radar signal. Receiving a time-domain radar signal may involve capturing an analog signal reflected off a target and converting it into a format suitable for further analysis. The signal may include modulated waveforms, such as frequency-modulated continuous-wave (FMCW) chirps, which carry information about the target's range, speed, and other properties. A radar receiver may process this incoming signal through an antenna, amplify it to strengthen weak reflections, and apply analog-to-digital conversion to produce a series of discrete time-domain samples. These samples may then be used for subsequent steps.

The process 310 may begin with a receiving antenna that collects the incoming electromagnetic waves. The captured signal may then be fed into a low-noise amplifier (LNA) to boost its strength without introducing significant additional noise. The amplified signal may be mixed with a reference signal from the radar's local oscillator to down-convert it into an intermediate frequency (IF) signal. This IF signal may then be filtered to remove unwanted noise and artifacts before being digitized by an analog-to-digital converter (ADC). The ADC may sample the signal at specific time intervals, converting it into a digital representation comprising discrete amplitude values over time. These digitized time-domain samples may then be stored or passed to the radar's signal processing unit for further analysis.

Further, method 300 includes performing 320 a short-time Fourier transform (STFT) on the time-domain radar signal to generate a time-frequency representation of the radar signal. Performing a STFT on the time-domain radar signal to generate a time-frequency representation involves analyzing how the frequency content of the radar signal changes over time. This process transforms the signal from its original time-domain form into a combined representation that shows both time and frequency information, allowing a detailed understanding of the signal's behavior. The time-frequency representation provides a way to visualize and process the radar signal for further analysis, such as identifying interference or target characteristics.

Performing the STFT may involve dividing the radar signal, which varies over time, into smaller overlapping segments to focus on short time intervals of the signal. For each time segment, a Fourier transform may be applied, which converts the signal from the time domain into the frequency domain, revealing the frequency components present during that segment. These frequency-domain representations may then be combined to create a time-frequency representation (spectrogram), which shows how the signal's frequency content evolves over time.

Performing the STFT on the time-domain radar signal may begin by segmenting the signal into overlapping or non-overlapping time windows based on predefined parameters, such as window length and overlap percentage. A windowing function, such as a Hamming, Hanning, Blackman, Chebyshev, Kaiser, or rectangular window, may be applied to each segment to reduce edge effects that can distort the frequency analysis. A discrete Fourier transform (DFT) may then be performed on each windowed segment, converting the time-domain data into a frequency-domain representation that identifies the magnitude and phase of the frequency components present during that time window. These frequency-domain representations may be compiled into a matrix, where each column corresponds to a specific time segment, and each row represents a frequency bin, or vice versa. This matrix forms the time-frequency representation, also known as a spectrogram, which provides a visual and numerical depiction of how the radar signal's frequency content changes over time.

Further, method 300 includes determining 330 differences between consecutive segments of the time-frequency representation to identify frequency variations indicative of interference. This involves analyzing changes in the radar signal's frequency content over time. This process focuses on detecting shifts or patterns in the signal's behavior that could indicate the presence of interference. By comparing segments of the time-frequency data, the method may identify irregularities that deviate from expected frequency characteristics. This process may involve comparing consecutive portions, or time segments, of the radar signal's time-frequency representation to detect variations in frequency content. For each time segment, the frequency information may be analyzed and compared to the adjacent segment(s) to calculate differences. These differences may reveal changes in the signal's behavior over time, such as frequency shifts or irregular patterns that might indicate interference.

Further, method 300 includes detecting 340 radar interference based on the identified frequency variations. Detecting radar interference based on the identified frequency variations involves determining whether unusual or irregular changes in the radar signal's frequency content indicate the presence of interference. This process uses the analyzed data to distinguish between normal variations in the signal and patterns that are characteristic of interference. The detection 340 may ensure that disruptions to the radar signal are identified for further processing or mitigation.

This process may involve evaluating frequency variations identified in the time-frequency representation to determine whether they are indicative of interference. By analyzing the magnitude and nature of these variations, the method may distinguish interference-related patterns from normal signal behavior. The detection may be based on predefined criteria, such as thresholds or specific characteristics of the frequency variations, to ensure accurate identification of interference within the radar signal.

Detecting radar interference based on the identified frequency variations may begin by comparing the calculated differences between consecutive segments of the time-frequency representation to a predefined detection threshold. This threshold may define the level of variation that is considered abnormal and likely caused by interference. If the frequency variations exceed this threshold, the method may classify the corresponding segments of the radar signal as affected by interference. The detection process may also include additional criteria, such as evaluating the persistence or spread of the variations across time and frequency, to refine the identification of interference. By isolating the segments associated with interference, the method may ensure accurate detection, enabling further steps such as signal reconstruction or transmission parameter adjustment.

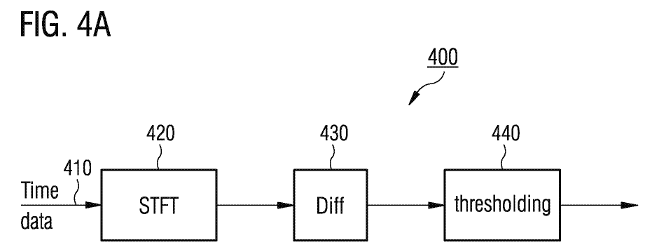

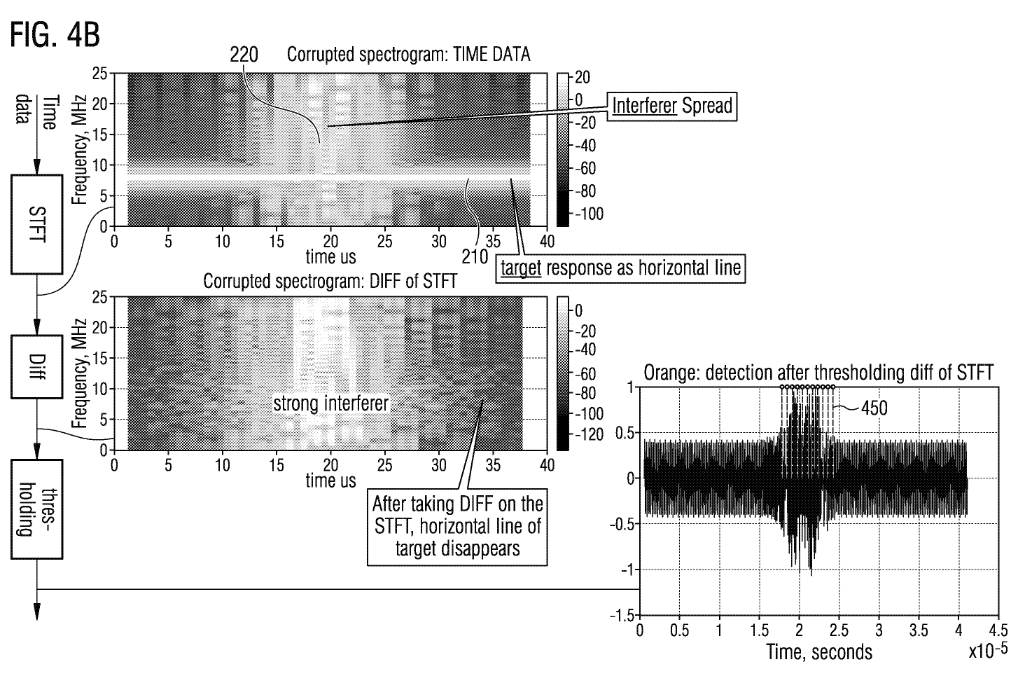

FIG. 4A illustrates a basic block diagram of an STFT-based algorithm for radar interference detection. The diagram outlines a step-by-step process starting from time-domain radar data and culminating in interference detection through thresholding.

The process begins with time data 410, which represents raw radar signal (e.g., IF signal) in the time domain. This input is fed into the STFT block 420, where the STFT is performed. Here, the radar signal is divided into overlapping or non-overlapping segments, a windowing function is applied to each segment, and a DFT is computed for each segment. The result is an STFT matrix that provides a time-frequency representation of the signal, capturing how the frequency content evolves over time. An example output (spectrogram) from the STFT block 420 similar to FIG. 2B is shown in FIG. 4B.

The output from the STFT block is passed to a Diff block 430. In this block 430, differences between consecutive (time) segments of the STFT matrix (spectrogram) may be computed. These differences may be calculated as absolute values to measure changes in frequency content between adjacent time segments. For a clean radar signal with no interference, these differences would ideally be close to zero since the frequency content remains stable over time (aside from noise or other minor variations). However, in the presence of interference, the differences become nonzero and often larger, reflecting the wideband characteristics and irregularity introduced by the interference signal.

Each time segment corresponds to a specific window of the radar signal in the time domain that has been transformed into the frequency domain using the STFT. Adjacent time segments may cover all STFT frequency bins. In the time-frequency representation (or spectrogram), each segment represents the frequency content of the radar signal during a particular time interval, divided into frequency bins. The "absolute difference" may be computed for each frequency bin across two consecutive time segments. This means that the difference is calculated between corresponding frequency components in the two segments to capture any changes in the signal's frequency content over time. This operation may be performed across all frequency bins within the STFT matrix, ensuring that changes in the signal's frequency structure at every frequency bin are accounted for when detecting interference. An example output from the Diff block 430 is shown in FIG. 4B.

The output of the Diff block 430 is then processed in a thresholding block 440. Here, the system applies one or more thresholds to the calculated differences to detect and locate segments affected by interference. This can employ various approaches, such as Constant False Alarm Rate (CFAR)-based thresholding or simple fixed thresholds. In some implementations, two-stage thresholding may be used. The first stage may identify the existence of interference by applying a broad detection threshold. Once interference is detected, a second, more refined threshold may be applied to pinpoint the specific time segments or frequency bins affected by the interference.

FIG. 4B illustrates how the horizontal line corresponding to the target response disappears after the DIFF operation, allowing the detection of interference signals.

In the first spectrogram after STFT 420, the horizontal line 210 represents the target response in the radar signal. This horizontal line is consistent across time because the target generates a constant IF frequency signal, whose IF frequency does not change over time. However, interference is visible as spread-out vertical patterns 220 across a range of frequencies. These patterns 220 overlap with the horizontal line 210, making it difficult to isolate interference visually in the spectrogram.

In the second spectrogram after Diff block 430, the difference (DIFF) operation is applied to consecutive segments of the STFT output. This operation computes the absolute difference between adjacent time segments, removing components that remain constant across time. As a result, the horizontal line 210 corresponding to the target response, which remains consistent across time, disappears. In contrast, the interference signal 220, which varies in frequency and intensity over time, becomes more prominent. The interference spreads across multiple frequencies, and its time-varying nature is clearly visible, allowing it to be distinguished from the target signal.

In the time-domain plot after the Thresholding block 440, the output after applying a thresholding step to the DIFF result is shown. The thresholding process identifies and highlights regions where the computed differences exceed a predefined threshold, corresponding to segments affected by interference. The detection overlay 450 indicates that the interference is successfully detected. The remaining parts of the signal are left untouched, confirming that the method selectively identifies interference while preserving clean signal segments.

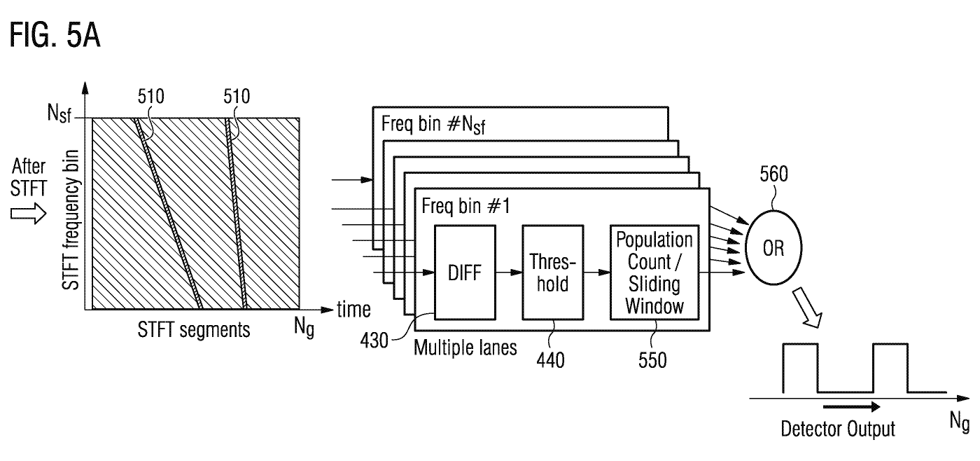

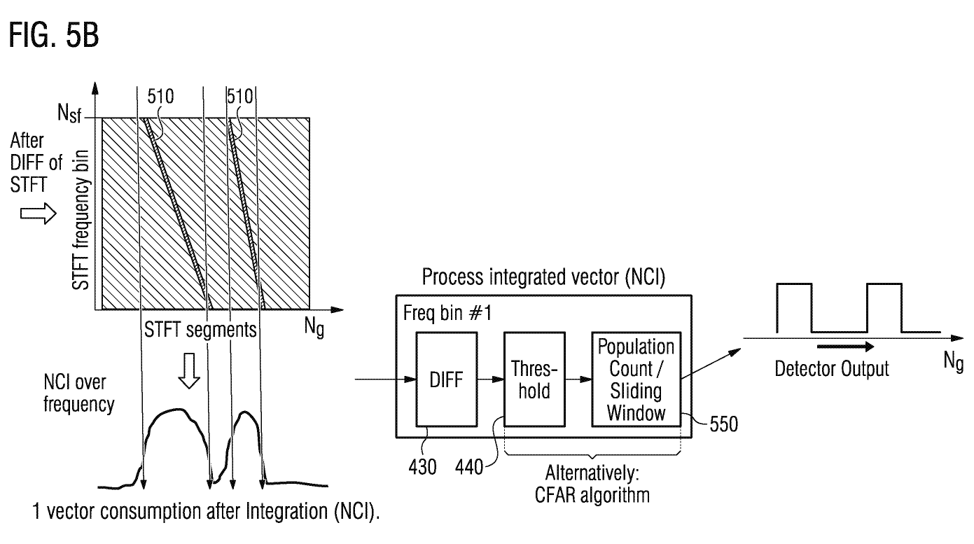

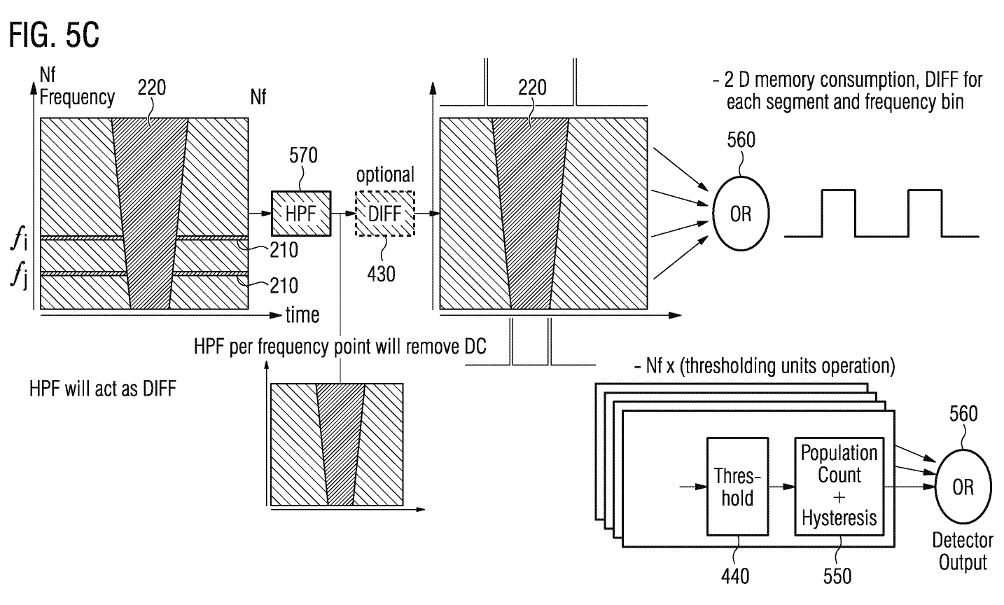

FIG. 5A illustrates an embodiment of the interference detection process for a radar system, leveraging the STFT to analyze time-domain radar signals. This process identifies interference based on frequency variations over time and incorporates modular, scalable processing steps for efficient detection.

On the left-hand side, the STFT output is represented as a time-frequency matrix, where the vertical axis corresponds to the STFT frequency bins (N_{sf}), and the horizontal axis corresponds to the STFT time segments (N_{g}). Each cell in this matrix contains the magnitude and phase information of the radar signal for a specific frequency and time segment. This matrix serves as the input for the subsequent interference detection process. The lines labeled as 510 in FIG. 5A schematically represent the presence of interference that spreads across all STFT frequency bins and respective STFT time segments. These lines illustrate an example behavior of interference as it affects the radar signal. Unlike a stationary target response, which would typically appear as a horizontal line at a specific frequency bin in the STFT matrix, interference may manifest as dynamic variations that traverse multiple frequency bins over time.

The middle section of FIG. 5A shows an example processing pipeline for detecting interference within each individual STFT frequency bin. The detection pipeline may operate in parallel across multiple STFT frequency bins, where each lane processes data from a single STFT frequency bin. The DIFF block 430 may calculate an absolute difference between consecutive time segments within a respective STFT frequency bin. This may identify variations in the frequency content over time, which may indicate interference. Stationary components, such as target reflections, may be effectively eliminated, allowing dynamic components (e.g., interference) to be emphasized. The threshold block 440 may apply a predefined or dynamically adjusted threshold to the computed differences. Differences exceeding the threshold may be classified as indicative of interference for the corresponding frequency bin and time segment. A Population Count/Sliding Window block 550 may aggregate the detection results over time and/or across segments to improve robustness. A sliding window may be used to ensure consistent detection of interference over a series of consecutive time segments, minimizing false positives or negatives.

The outputs from all frequency bins may then be logically combined e.g. in an OR block 560, as shown on the right-hand side. This operation may ensure that if interference is detected in any frequency bin, it contributes to the overall detection result.

Finally, a detector output may represent the interference detection results over time (N_{g}). The output may be a binary signal where a value of "1" may indicate the presence of interference, and a value of "0" may indicate no interference. This binary representation may provide a clear, actionable signal that can be used for further processing or mitigation steps, such as adjusting radar transmission parameters or applying signal reconstruction techniques.

The depicted system of FIG. 5A may efficiently process the STFT output to detect interference while preserving scalability. By processing each STFT frequency bin independently and combining results across bins, the system may ensure reliable interference detection in complex radar environments. This approach is adaptable to different radar configurations and noise conditions, offering flexibility for various applications.

FIG. 5B illustrates another embodiment of the radar interference detection process that incorporates Non-Coherent Integration (NCI) to improve interference detection reliability and simplify data processing.

On the left-hand side of FIG. 5B, the STFT representation of the radar signal is shown. Similar to FIG. 5A, the vertical axis represents the STFT frequency bins (N_{sf}), while the horizontal axis represents the STFT time segments (N_{g}). The slanted lines labeled 510 again indicate the presence of interference spreading across multiple frequency bins and time segments, demonstrating its wideband, time-varying nature.

FIG. 5B includes a processing step using NCI. This step may aggregate energy across all STFT frequency bins for each time segment in the STFT representation, effectively collapsing the multi-bin interference data into a single vector. The result of this integration is shown below the STFT representation, where the interference manifests as prominent peaks in the integrated vector. By consolidating information across frequency bins, the NCI step may simplify subsequent processing and improve the ability to detect interference patterns.

The right-hand side of FIG. 5B shows a corresponding processing pipeline. The integrated vector produced by the NCI step may be fed into further interference detection blocks. These blocks may include the DIFF operation 430, thresholding 440, and population count or sliding window methods 550. Alternative to thresholding 440, and population count or sliding window methods 550, a Constant False Alarm Rate (CFAR) algorithm may be employed. The CFAR algorithm may dynamically adjust a threshold based on the noise floor, improving detection accuracy in varying noise conditions. The final detector output represents a binary signal, where a value of "1" indicates detected interference, and "0" indicates no interference.

The difference between FIGS. 5A and 5B lies in the inclusion of the NCI step in FIG. 5B. While FIG. 5A processes the STFT data directly for each frequency bin, FIG. 5B integrates the energy across all frequency bins before proceeding to thresholding and detection. This integration may reduce the data's dimensionality and enhance the ability to detect interference by emphasizing time-domain variations while suppressing random noise across frequency bins.

FIG. 5C illustrates an embodiment of the radar interference detection process that incorporates a high-pass filter (HPF) applied to the STFT output to remove stationary target components 210, also referred to as DC components. This approach may ensure that only dynamic variations, such as those caused by interference, are preserved for further processing. The figure also demonstrates the optional inclusion of a difference (DIFF) operation following the HPF output, allowing flexibility in the detection pipeline configuration.

On the left-hand side of FIG. 5C, the STFT output is represented as a time-frequency matrix, where the vertical axis corresponds to the STFT frequency bins (N_{f}), and the horizontal axis corresponds to time. The stationary target components, shown as horizontal lines 210, may be removed by a HPF 570, which acts as a filtering mechanism to eliminate DC components across all frequency bins. The result 220, is a filtered representation that highlights only dynamic signal components, such as interference.

FIG. 5C also shows an optional DIFF operation 430, which can be applied to the HPF output. The DIFF operation 430 may calculate differences between consecutive time segments for each frequency bin, further enhancing the detection of time-varying components. Whether the DIFF operation 430 is applied or bypassed may depend on the specific requirements of the implementation. The filtered or filtered-and-differenced output may then be processed through a parallel detection pipeline.

The detection pipeline, shown on the right-hand side, may operate in parallel across all frequency bins in the STFT representation. Each lane may process data from a single frequency bin and may include thresholding 440 followed by population count and hysteresis operations 550. The thresholding 440 may determine whether the signal exceeds a predefined or adaptive threshold, which is indicative of interference. The population count and hysteresis operations 550 may refine the detection by aggregating results over time or applying state-dependent criteria to improve detection stability and reduce false positives.

The results from all frequency bins may be combined using an OR operation 560, ensuring that interference detected in any bin contributes to the overall detector output. The final detector output may be a binary signal indicating the presence or absence of interference over the time segments (N_{g}).

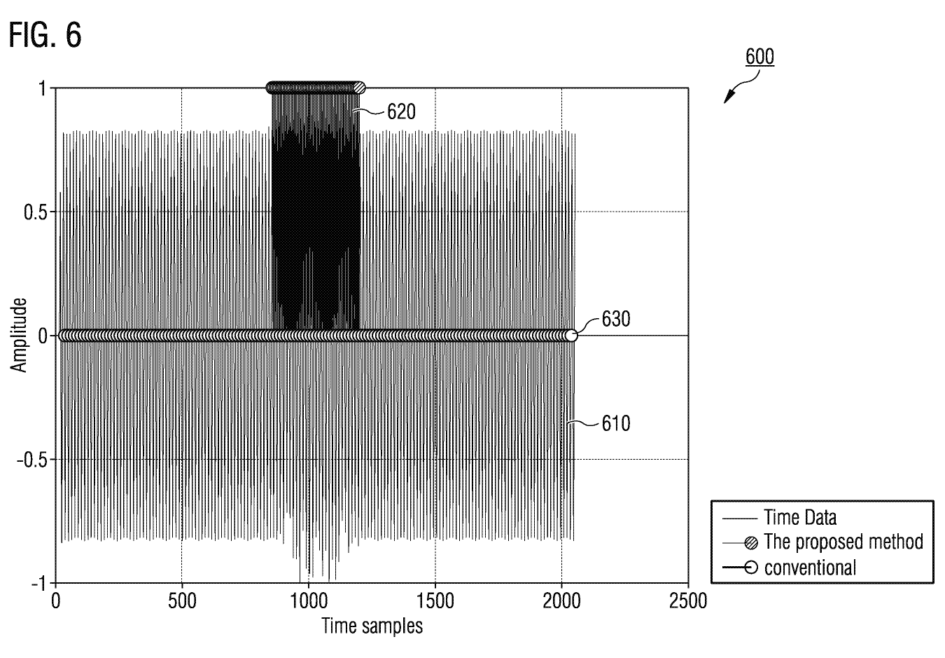

FIG. 6 illustrates the performance of the proposed interference detection in the case of a weak interferer using a single target simulation with an ideal radar model. FIG. 6 plots a normalized time-domain radar signal 610, as well as detection results of two methods: the proposed method 620 and a conventional method 630. The horizontal axis represents time samples, while the vertical axis shows amplitude for the time data and detection values for the methods.

The time-domain radar signal 610 exhibits a continuous sinusoidal-like waveform with consistent amplitude across most time samples. This represents the normalized radar signal, with the weak interference embedded within it. Since the interference is weak, it is not visually discernible in the time-domain data.

The detection results for the two methods are overlaid on the same graph 600. The proposed method 620 may detect interference effectively in the time segment where the interference occurs, indicated by a sharp rise to a value of 1. This detection is localized and corresponds accurately to the period of interference. Outside this region, the detection value is zero, showing that the proposed method does not falsely detect interference where it is not present. The conventional method 630 shows no detection throughout the signal, remaining consistently at a value of zero. This indicates that the conventional method fails to detect the weak interferer in this scenario, highlighting its limitation in identifying subtle interference patterns.

FIG. 6 demonstrates superior performance of the proposed method over conventional methods. The proposed method may accurately detect weak interference, enabling improved interference mitigation and avoidance strategies. This capability may enhance the robustness of radar systems in dealing with weak and otherwise hard-to-detect interference, which can be critical for applications in environments with complex interference scenarios.

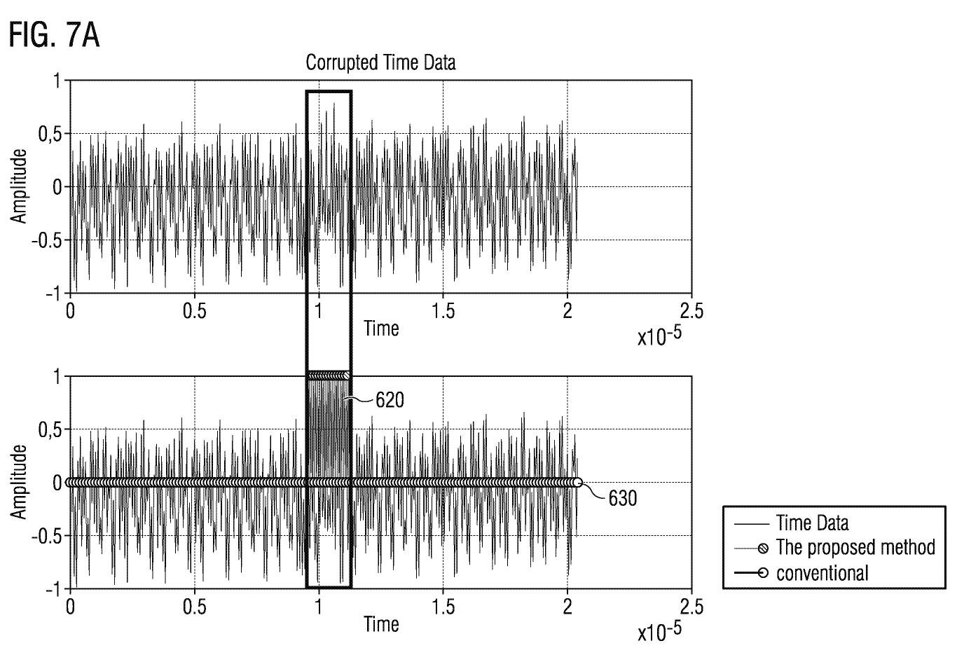

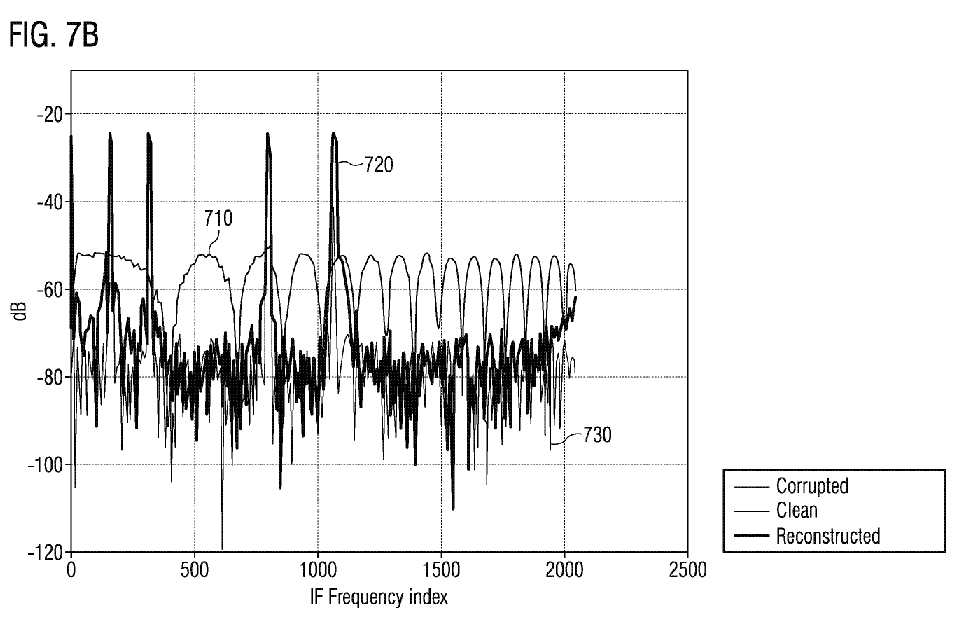

FIGS. 7A and 7B illustrate the performance of the proposed method in a realistic simulation environment that includes weak interference, four radar targets, RX noise, and other impairments. The figures compare the proposed method to a conventional method and demonstrate its effectiveness in interference detection and mitigation.

FIG. 7A displays the time-domain data, showcasing corrupted radar signal, along with the detection outputs from the proposed method and a conventional method. The top plot shows the corrupted time data, where the weak interferer is present but not visually discernible due to its low power relative to the main radar signal and noise. This indicates the challenge of detecting weak interference directly from time-domain data. The bottom plot overlays the detection outputs of the proposed method 620 and the conventional method 630 on the same time-domain data. Line 620 representing the proposed method successfully identifies the time segment containing the interference, with a detection value of 1 in the corresponding region. In contrast, line 630 representing the conventional method remains at a detection value of 0 throughout, indicating its failure to detect the weak interferer under these conditions. This comparison demonstrates the superior detection capability of the proposed method in scenarios involving subtle interference.

FIG. 7B provides a frequency-domain comparison, illustrating the impact of interference on the signal quality and the effectiveness of the proposed interference mitigation technique. Line 710 represents the corrupted radar signal, which shows increased noise levels across the frequency spectrum due to the weak interference and other impairments. Line 720 represents the signal after reconstruction using the proposed method, which significantly reduces the noise level and improves the signal quality. Line 730 represents the clean reference signal without interference or noise.

The reduced noise level achieved through the reconstruction algorithm demonstrates the proposed method's ability to mitigate interference effectively. By identifying and addressing the corrupted samples, the proposed method enables to restore the signal's integrity, allowing for the detection of weak targets that would otherwise be obscured by the elevated noise floor.

Embodiments of the proposed concept may accurately detect weak interference that is not visually apparent in the time-domain data, while conventional (time domain based) detection methods fail to do so. The proposed method may reduce the noise floor significantly, bringing the corrupted signal closer to the clean reference signal in terms of quality. This improvement may enhance the radar system's ability to detect weak targets.

The figures collectively highlight the robustness of the proposed method in detecting and mitigating weak interference in realistic scenarios. Additionally, the proposed method leverages the flexibility of STFT configuration and benefits from FFT hardware accelerators, enabling a balance between computational complexity and detection accuracy. This adaptability further strengthens the proposed method's applicability to complex radar environments.

To summarize, embodiments encompass a method and apparatus for detecting radar interference in a radar system. At its core, the concept involves processing a time-domain radar signal to generate a time-frequency representation using a Short-Time Fourier Transform (STFT). By analyzing the differences between consecutive segments of the time-frequency representation, the system identifies frequency variations indicative of interference. This interference detection process ensures the reliability of radar systems by mitigating the effects of unwanted signals.

This may provide flexibility through various configurations. The STFT may be performed by dividing the signal into segments, applying windowing functions, and using discrete Fourier transforms (e.g., FFTs) to produce the time-frequency representation. Different windowing functions, such as Hamming, Hanning, or Blackman, can be employed, and the parameters for window length and step size may be configurable based on the radar signal's characteristics, such as chirp length. These adjustable parameters make the concept adaptable to various radar systems and interference scenarios.

Interference detection may be further enhanced through the use of threshold-based detection techniques. The concept supports both single-stage and two-stage thresholding, enabling the identification of interference at a broad level as well as isolating specific time segments or frequency bins affected by interference. Thresholds can also be dynamically adjusted based on the noise floor of the radar signal, ensuring robust performance under varying noise conditions. For more advanced detection, the concept may incorporate Non-Coherent Integration (NCI) to aggregate data across frequency bins and employs a Constant False Alarm Rate (CFAR) algorithm to dynamically adapt detection criteria.

To refine interference detection, the concept may introduce additional preprocessing steps, such as applying high-pass filters to the time-domain signal or to frequency bins in the spectrogram. These steps may remove stationary components, such as reflections from static targets, to focus on dynamic interference signals. The concept may also support the use of hardware-accelerated processors, such as FFT accelerators, to improve computational efficiency.

Embodiments may extend the method to include interference mitigation and adaptive radar operations. For example, the system may reconstruct the radar signal by mitigating the effects of interference based on the detected frequency variations, improving the quality of the signal for subsequent processing. Machine learning algorithms trained to distinguish between clean signals and interference-affected signals can also be used to enhance detection capabilities. Embodiments may further adjust radar system parameters, such as chirp length or transmission settings, in response to detected interference, ensuring continued system performance in challenging environments.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for detecting radar interference in a radar system, comprising:
receiving a time-domain radar signal;
performing a short-time Fourier transform, STFT, on the time-domain radar signal to generate a time-frequency representation of the radar signal;
determining differences between consecutive segments of the time-frequency representation to identify frequency variations indicative of interference; and
detecting radar interference based on the identified frequency variations.

2. The method of claim 1, wherein performing the STFT on the time-domain radar signal comprises
dividing the time-domain radar signal into a plurality of segments in accordance with a defined windowing parameter;
applying a windowing function to each segment;
performing a discrete Fourier transform, DFT, on each windowed segment to obtain a frequency-domain representation of that segment; and
combining the frequency-domain representations of the segments to form the time-frequency representation including magnitude and phase information across time and frequency.

3. The method of claim 2, wherein the windowing function applied to the segments is selected from a group comprising a Hamming window, a Hanning window, a Blackman window, and a rectangular window.

4. The method of claim 2, wherein a window length is configured to be equal to or shorter than a chirp length of the radar signal, and a step size between consecutive windows is defined as a fixed fraction of the window length.

5. The method of claim 1, wherein detecting radar interference comprises
applying at least one threshold-based detection criterion to the determined differences; and
identifying time segments of the radar signal as containing radar interference based on differences that exceed the at least one threshold-based detection criterion.

6. The method of claim 1, wherein detecting radar interference comprises a two-stage thresholding process, wherein
a first threshold is applied to detect a presence of interference; and
a second threshold is applied to identify specific frequency bins or time segments of the time-frequency representation affected by interference.

7. The method of claim 1, wherein determining differences between consecutive segments of the time-frequency representation comprises
for each frequency bin, computing an absolute difference between corresponding elements in the consecutive segments.

8. The method of claim 1, wherein detecting radar interference comprises
comparing the determined differences to a predefined threshold to identify segments with frequency variations indicative of interference; and
classifying the segments with differences exceeding the threshold as indicative of radar interference.

9. The method of claim 8, further comprising
dynamically adjusting the predefined threshold based on a noise floor level of the radar signal, the noise floor being determined by analyzing magnitude values of the time-frequency representation over a predefined time and frequency range.

10. The method of claim 1, further comprising
applying non-coherent integration, NCI, across frequency bins in the time-frequency representation.

11. The method of claim 1, wherein detecting radar interference comprises
employing a constant false alarm rate, CFAR, algorithm to dynamically adjust detection thresholds based on a noise floor across frequency bins.

12. The method of claim 1, further comprising
applying a high-pass filtering operation (570) to each frequency bin in a spectrogram.

13. The method of claim 1, further comprising
prior to performing the STFT, applying a high-pass filter to the time-domain radar signal.

14. The method of claim 1, wherein the STFT is performed using a hardware-accelerated fast Fourier transform, FFT, processor.

15. The method of claim 1, further comprising
dynamically adjusting a chirp length of the radar signal during operation based on the detected interference.

16. The method of claim 1, further comprising
reconstructing the radar signal by mitigating interference based on the identified frequency variations.

17. The method of claim 1, further comprising
analyzing the time-frequency representation using a machine learning algorithm trained to distinguish between clean signals and signals affected by interference.

18. The method of claim 1, wherein the radar system is a frequency-modulated continuous-wave, FMCW, radar system.

19. The method of claim 1, further comprising
altering transmission parameters of the radar system upon detecting interference.

20. An apparatus for detecting radar interference in a radar system, comprising processing circuitry configured to
receive a time-domain radar signal;
perform a STFT on the time-domain radar signal to generate a time-frequency representation of the radar signal;
determine differences between consecutive segments of the time-frequency representation to identify frequency variations indicative of interference; and
detect radar interference based on the identified frequency variations.
